(19) United States
(12) Patent Application Publication
(10) Pub. No.: US 2022/0207048 A1
(43) Pub. Date: Jun. 30, 2022

(54) SIGNAL OF TRUST ACCESS PRIORITIZATION

(71) Applicant: EMC IP Holding Company LLC, Hopkinton, MA (US)

(72) Inventors: Nicole Reineke, Northborough, MA (US); Michael Estrin, Hopkinton, MA (US)

(21) Appl. No.: 17/134,903

(22) Filed: Dec. 28, 2020

(51) Int. Cl. G06F 16/2457

(52) U.S. Cl. CPC G06F 16/24578; G06F 16/24573

(57) ABSTRACT

One example method includes receiving from a user, by a trust algorithm, primary input that comprises a user query that specifies search parameters, a list of one or more trust factors, or is automatically assigned a list of trust factors based on organizational requirements, and a respective user-specified weighting for each trust factor definition, receiving secondary system inputs and, based on the search parameters, retrieving data from the secondary system inputs, running, on the data retrieved from the secondary system inputs, one or more trust factor functions, each of which generates a respective trust factor, generating a trust score by running a trust score function on the trust factors, aggregating the data with the trust score to create a result set, and storing the result set.

### FIELD OF THE INVENTION

Embodiments of the present invention generally relate to data, and the suitability of data for particular uses. More particularly, at least some embodiments of the invention relate to systems, hardware, software, computer-readable media, and methods for the implementation and use of data trust mechanisms that may be used to determine the suitability, or not, of data for one or more particular purposes.

### BACKGROUND

Some Chief Data Officers (CDOs) have indicated that one of the largest challenges they have is establishing confidence that data being used for creating models, dashboards and reports, and other business functions, is suited for the purpose for which that data is being used. This concept is sometimes referred to as data trust. In light of this, what is needed are mechanisms that may help to determine the suitability of data for one or more particular purposes.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses information priorities in the area of dataset trustworthiness.

FIG. 2 discloses aspects of an example workflow for evaluating the trustworthiness of a dataset.

FIG. 3 discloses aspects of an example method and architecture for evaluating the trustworthiness of a dataset.

FIG. 4 discloses aspects of a computing entity operation to perform any of the disclosed methods, operations, and processes.

### DETAILED DESCRIPTION OF SOME EXAMPLE EMBODIMENTS

Embodiments of the present invention generally relate to data, and the suitability of data for particular uses. More particularly, at least some embodiments of the invention relate to systems, hardware, software, computer-readable media, and methods for the implementation and use of data trust mechanisms that may be used to determine the suitability, or not, of data for one or more particular purposes.

In general, example embodiments of the invention embrace models that may, among other things, enable trust factors, that is, one or more data aspects identified as having some measurable value to or material impact on the measurement of trust, as a mechanism of prioritization of data access based on the intended utilization of data and the context in which data will be utilized, including the formation of datasets.

In more detail, some example embodiments of the invention embrace the creation and use of mechanisms that may be effective in establishing repeatable, variable, traceable trust factors, and that may enable business variables to influence the ranking mechanism, such as by use case/need/project for example, to generate a trust score, and return data and datasets in a prioritized manner based on trust. Such mechanisms may, for example, enable context and point-in-time based, repeatable, user-influenced result sets optimized for modern data science needs.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, an advantageous aspect of one embodiment of the invention is that a user may be able to access trust data and/or trust metadata that the user may employ to gain some level of assurance that the associated data which the user intends to employ is suitable for the intended purpose. An embodiment may permit changes to the trust associated with particular data as conditions change. An embodiment may enable different users, who may anticipate different respective uses of data, to define and implement their own respective conception of what does, and does not, constitute trustworthy data, even when those users are using the same dataset for different respective purposes.

### A. OVERVIEW

Following is a discussion of some challenges that may be resolved by one or more embodiments. This discussion is not intended to limit the scope of the invention in any way.

In a number of CDO interviews conducted in 2020, an inability to understand if data was “trustworthy” for the purpose it was being used was ranked as a top concern. Study details at: (https://www.delltechnologies.com/resources/en-us/asset/white-papers/solutions/cdo-perspectives-how-to-achieve-data-management-maturity.pdf).

Analysis of the interviews established that most CDOs indicated that data which they created in-house was considered to be inherently trustworthy. However, all respondents indicated that they use external data and purchase external datasets as part of model and report generation for decision making. For this reason, it is useful to establish and employ a mechanism of measuring trust for both internal and external data that goes beyond basic assessments of lineage and security of such data.

It is also noted that factors of data trust may vary and are not currently handled by any single solution. For example and based on the aforementioned interviews, the very definition of what makes data trustable is deeply varied by organization. Furthermore, analysis of such interviews established that ‘trust’ may be fragile, as well as being subject to change as new events occur or time passes. For this reason, at least, it is not particularly useful or effective to measure trust as a ‘one time’ occurrence, or as a single measurement on a piece or group of data. A more fluid and flexible conception of trust is likely a better approach.

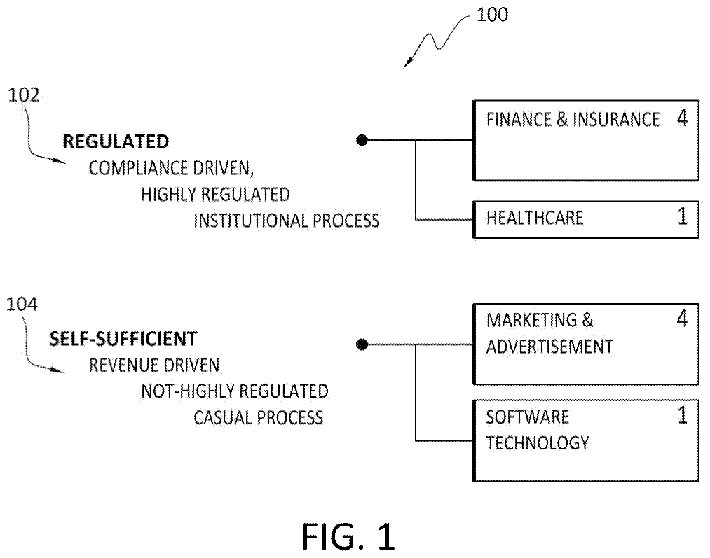

With further reference to the aforementioned study, half of the CDOs interviewed were concerned primarily with compliance, regulation and institutional processes. This group 102, referred to as ‘Regulated’ in FIG. 1, identified risk-avoidance as a primary objective of their organization. Several referenced the prioritization of projects to match with 1-year and 3-year plans. The other half of the CDOs, referred to as ‘Self-Sufficient’ in the example breakdown 100 in FIG. 1, identified increasing revenue as a primary objective. This second group 104 did not have deep institutional processes as a primary driver of projects. Rather, their focus was on several prioritized projects by customer size and opportunity, with shorter timeframes for project deliveries.

As seen in FIG. 1, alignment in one of the two groups was strongly correlated by industry/vertical. CDOs in the first group had extensive investments in existing tools, and some of the CDOs in the second group had adopted some form of data management tooling. However, even with extensive systems in place, the CDOs were unable to establish if particular data could be “trusted” for the purpose for which that data and datasets needed to be used.

When respondents in the aforementioned study were specifically asked what would be required to make data “trustable,” the following trends became apparent.
Four respondents cited data origin as a trust factor. Two respondents specifically stated that data created by their organization is considered inherently trustworthy. This may imply a requirement to track, and attest to, the origin of data.
Ownership of the data is an inferred trust factor. Ownership and origin of data are loosely related. Where the origin may be static, ownership can change over time. This may imply a requirement to track, and attest to, the ownership of data.
Two respondents cited data cleanliness, conformance and consistency as trust factors influencing an assessment as to whether or not particular data was trustworthy.
The trust factors of data cleanliness and conformance were expressed as intra-data concerns—that data included expected properties and those properties conformed to expected rules. This may imply a requirement to evaluate conformance of data to a particular specification.
The trust factor of data consistency was expressed as an inter-data concern—that specific data is within an acceptable deviation of other data of the same type. This may imply a requirement to compare data, as part of a consistency evaluation, to specified tolerances, which may be static or dynamic in nature.
One respondent cited repeatability as a trust factor. That is, a subsequent trust factor assessment, given the same inputs, should return the same result. A subsequent trust score, given the same trust factor assessments as inputs, should return the same result. This may imply a requirement for portable assessment and scoring implementations to enable assessment and scoring to be repeated across time, using a copy of the original data, and/or by different, and potentially distributed, systems.
An important facet of the repeatability trust factor is the ability to reproduce an assessment or score for data as of a given point in time. This may imply requirements to track changes to trust factor inputs temporally and to be able to recreate the state of those inputs as of a specific moment in time.
Other trust factors identified include recency, or ‘newness,’ of the data, intended destination of the data, intended use of the data, and bias-neutrality.

In addition to the factors identified in the survey, it is noted further that particular data may be used for more than one purpose, and the requirements on data trust vary even within a single organization. To illustrate, a particular record or piece of data may be used by more than one employee or process, or as an automated input, in more than one context. The respective trust requirements for each employee, for example, may be different. Thus, a single piece or set of data may have multiple different sets of trust requirements. Therefore, a single trust score associated with a piece of data may not meet the needs of all CDOs or even on the data within a single company if the data is used across multiple projects.

### B. ASPECTS OF SOME EXAMPLE EMBODIMENTS

In general, example embodiments of the invention may create and employ a data trust mechanism that may be used across organizations, considering user needs, business capabilities, business priorities, and may establish the traceability of the score for repeatability and variation in secondary requests.

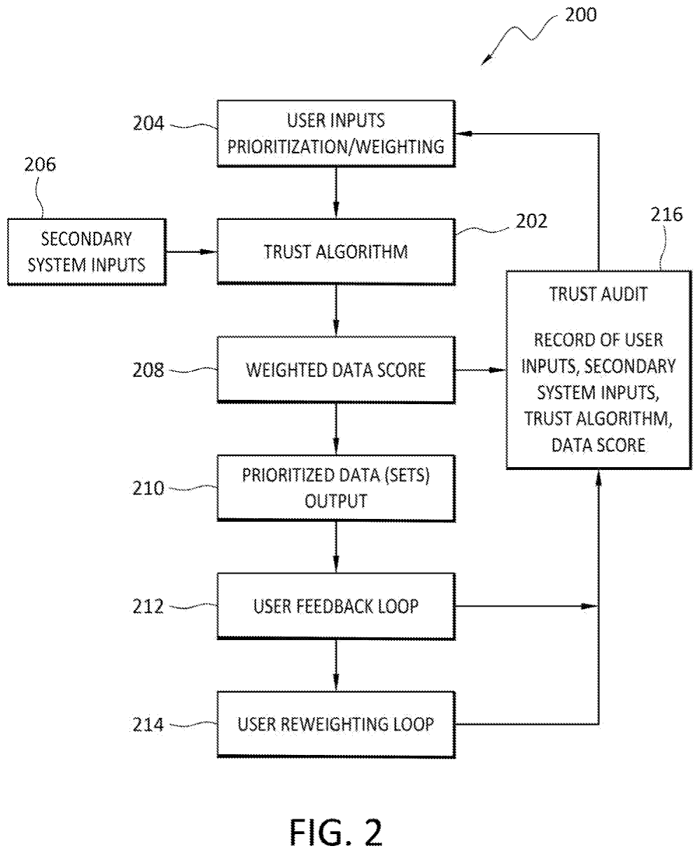

With reference now to FIG. 2, an example method 200 is indicated. The method 200, and its components, need not be executed at any particular site or sites, but in some embodiments, an algorithm that comprises the method 200 may run at a user or enterprise site. In some embodiments, the algorithm may run, in part or in whole, at a datacenter, such as a cloud datacenter or on-premises datacenter, where the enterprise data is stored, and instantiation of the algorithm may be triggered by a user at a user site.

As a possible, but not mandatory, prerequisite to performance of the example method 200, a baseline ‘accessible/appropriate’ data discovery process, based on a user catalog query, may act as an initial filter on, or definition of, a data request. Thus, this data discovery process may, at least generally, identify one or more datasets that are responsive to the catalog query, and accessible to the user.

Performance of some embodiments of the method 200 may be centered on the operation of a trust algorithm 202 which, in general, may operate to combine various types of inputs and, based on those inputs, create an on-demand bespoke trust analysis of one or more datasets. In more detail, the trust algorithm 202 may be configured to receive any of a variety of inputs that may be used in the assessment, by the trust algorithm 202, of the trustworthiness of a dataset, and the generation, by the trust algorithm 202, of one or more trustworthiness scores concerning the dataset. The trust algorithm 202 may, for example, operate recursively to perform such functions automatically any time an input value is changed, added, or eliminated, and/or at any other time. The trust algorithm 202 may, for example, run according to a set periodic schedule, and/or may run ad hoc in response to a user request, or in response to the occurrence of a triggering event. More generally, the trust algorithm 202 may run any time any of its functions is deemed to be needed.

As shown in FIG. 2, the trust algorithm 202 may receive a set of primary inputs 204 and/or a set of secondary inputs 206. The primary inputs 204, denoted as ‘User Inputs Prioritization/Weighting’ in FIG. 2 may be based on current need, and the ‘User’ may be a human, or automated algorithm access, or any other entity. The primary inputs 204 may comprise, for example, user inputs concerning user prioritization of trust factors to be evaluated by the trust algorithm 202. That is, some trust factors may be relatively high priority for some users, but relatively low priority for other users. The primary inputs 204 may additionally, or alternatively, comprise weighting information that identifies the relative weights assigned by the user to one or more of the trust factors identified by the user and input to the trust algorithm 202. In some embodiments, respective primary inputs 204 and/or respective secondary inputs 206 may be received from multiple different users, such that the output of the trust algorithm 202 may assess the trustworthiness of data, and assign trust scores, based on the inputs of multiple users.

The trust algorithm 202 may also receive the secondary inputs 206 that may be accorded, by the trust algorithm 202, relatively lesser consideration or weight than accorded to the primary inputs 204 by the trust algorithm 202. In some embodiments, the secondary inputs 206 may be omitted and trust information generated by the trust algorithm 202 based only on the primary inputs 204. Examples of secondary inputs 206 may comprise, but are not limited to, metadata from the data sources such as the owner/nature/location of the data source, creation date of the data from the data source, BIOS info of a data source such as a sensor, data source IP address, and AWS catalog information. Note that as used herein, ‘data source’ is broadly construed an embraces, but is not limited to, any hardware, software, system, or any combination of these, that operates to generate new and/or modified data.

Using inputs, which may comprise the primary inputs 204 and/or secondary inputs 206, the trust algorithm 202 may then calculate a weighted data score 208 of the data identified by the user, where the weighted data score 208 comprises, or consists of, a trust value or trust score, which may be numerical, of that data. As noted above, such data may be identified by a user, such as through the user of a query, prior to operation of the trust algorithm 202, and the data, or data identifiers/pointers, provided to the trust algorithm 202 so as to enable the trust algorithm 202 to evaluate the data.

After the weighted data score(s) 208 concerning the data have been generated, one or more prioritized datasets 210 may be output by the trust algorithm 202. A prioritized dataset 210 may be a dataset whose trust value was calculated by the trust algorithm 202 and has been determined by the trust algorithm 202 to meet, or otherwise be consistent with, the prioritized trust factors identified by the user.

A user feedback loop 212 may receive the prioritized datasets 210, and feedback from the user concerning, for example, the perceived, by the user, suitability of the prioritized datasets 210 for the intended purposes of the user. The user feedback, the user reweighting input from a user reweighting loop 214, along with the weighted data scores 208, may be provided as inputs to a trust audit module 216.

The trust audit module 216 may create a record of the weighted data score 208, which may be done immediately after the weighted data score 208 is calculated by the trust algorithm 202, or at another time. The record may include the weighted data score 208 and identification of the datasets to which that weighted data score 208 corresponds. The trust audit module 216 may also keep records of inputs such as the primary inputs 204 and secondary inputs 206. The trust audit module 216 may store the trust algorithm 202, and weighted data scores 208, for use in performing audits, and recalculation of trust scores such as the weighted data scores 208.

Note that while some embodiments embrace a process to create the trust scores based on rules, such as user input, other embodiments may alternatively, or additionally, be implemented as a tally performed automatically as part of a ML (Machine Learning) training at the time the business creates the risk score tolerance, that is, when the business/user defines prioritized trust factors. This initial ML process may be later augmented with one or more performances of the method 200.

With the foregoing discussion in view, further details are now provided concerning example aspects of some embodiments, one of which concerns cross-organizational “trust analysis” capability for personalized prioritization of data using a traceable, repeatable, needs-based, analysis. In general, this aspect provides that the measurement of trust, whether in the form of a trust factor assessment or a trust score, may be tied to a specific moment in time, and to a specific user need. Any data, such as an object for example, may at any point have many needs and measurements.

The trust audit aspect of example embodiments of the invention embraces the notion that a specific trust measurement may continue to be accurate for some period of time, potentially indefinitely, post-measurement, that is, after the measurement is taken or generated. Given the encapsulated nature of the functions that may implement one or more facets of a trust measurement process, it may be the case, in at least some instances, that the only way to definitively determine the on-going accuracy of the last trust measurement is to repeat the measurement, and possibly compare the two measurements to identify any drift, or change, in the trust measurement that may have occurred during the respective points in time of the two measurements.

Moreover, by separating, on a functional basis at least, the “User Input Prioritization” (see reference 204 in FIG. 2, for example) from the “Trust Algorithm” (see reference 202 in FIG. 2, for example), embodiments may allow for the fact that individual trust factors identified via customer interview, or most any other trust factor, may be highly subjective, based as they are on user opinions and perspectives as to what does or does not constitute trustworthy data. In fact, one only need look at the variance in customer-identified trust factors for supporting evidence of their subjective nature. For example, assessment of the trust value derived from confirming data originated where expected will likely differ from one evaluator to another. Thus, architectural approaches, such as the example architectural approach of FIG. 2, may allow for interpretive variation when calculating trust, rather than simply relying only on a single ubiquitous referential algorithm to assess a specific trust score.

Any of the trust factors identified in customer interviews, which may be conducted in-person, or by way of a user interface (UI), may be codified by a function, one embodiment of which is a trust algorithm (see reference 202 of FIG. 2, for example). At least some embodiments of the trust algorithm may execute the bespoke function to arrive at a trust factor assessment, and may use one or more secondary sources, such as access to the data, its metadata, and/or other data instances of the same type, as inputs to the trust factor assessment. The trust factor assessments may be aggregated and evaluated by the trust algorithm to arrive at a trust score.

Data, data sets and/or other results may be returned and ordered with, and by, the trust score generated by the trust algorithm. Additionally, users may specify, as a filtering mechanism, that data must meet a minimal threshold. A dataset, for example, that does not meet a trust score threshold may be marked, such as by the trust algorithm, as failing to meet user criteria. At this point, the user may rework the inputs and submit those through a feedback loop to see if a recalculation of a trust score by the trust algorithm will indicate whether the failed data set now constitutes adequately trustworthy data. These approaches, such as the use of a filtering mechanism for example, may enable a dramatically improved upfront data selection process since the user does not have to examine multiple datasets to determine their acceptability, and correspondingly reduce post processing needs.

Yet another useful aspect of some embodiments concerns context-based trust scores that may enable multiple scores by data, that is, multiple scores assigned to the same dataset according to respective criteria specified by multiple different users. Through the use of such processes, embodiments of the invention may be able to create varying trust scores that are appropriate for the context in which the data will be used. Moreover, the trust audit (see reference 216 in FIG. 2, for example) ensures that all score generation is repeatable and can be used in a feedback loop for users to tune their input and prioritization for ideal data and data set access.

Moreover, at least some embodiments provide that a trust score calculated and assigned to data is not an immutable or singular measurement of the trustworthiness of that data. Rather, and as provided by at least some embodiments, any data can have any number of trust scores that are aligned to the respective user input (see reference 204 of FIG. 2, for example) of multiple different users, and aligned to the point in time at which the score was requested. It is also noted that in a system-based implementation of some example embodiments of the invention, user inputs may be stored and reused as templates for repeatable access, and to save user time in generating calculation of a trust assessment of data. Finally, in some embodiments, the system may suggest, such as to a user, particular inputs to a trust algorithm based on other parameters, datasets, a user profile, or inputs provided by another user. These suggestions may be made as part of an ML process, but that is not required.

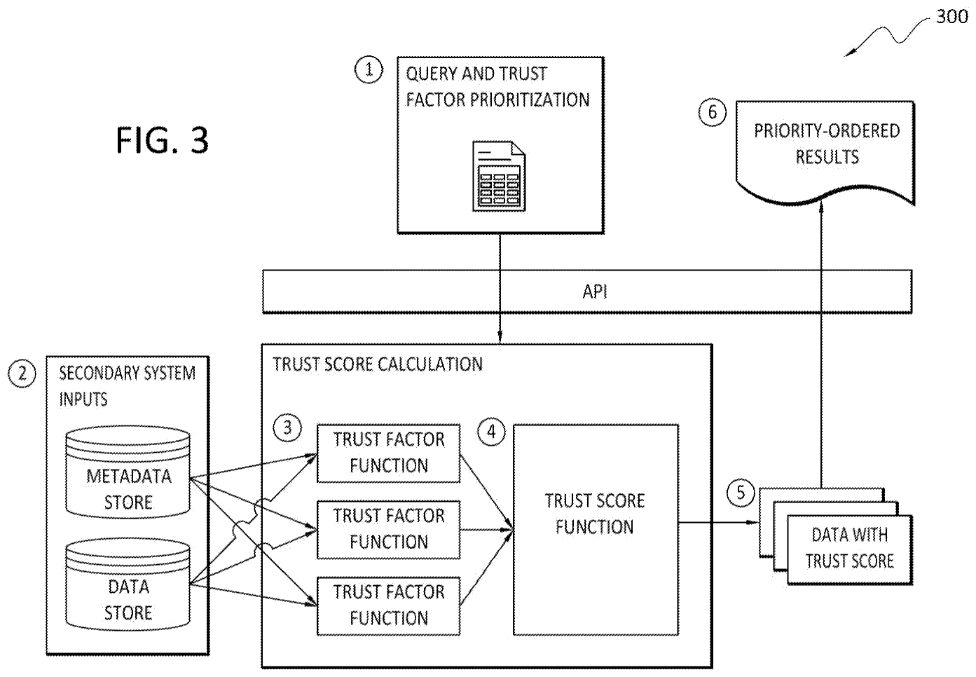

With reference now to FIG. 3, aspects of an example use case, including an example method 300, are disclosed. In general, this illustrative use case may provide queryable access to a user via an API (Application Program Interface) to one or more datasets, and may then return a result in which the datasets responsive to the query are ordered according to customizable prioritization or weighting of individual trust factors that have been applied to the datasets by a trust algorithm. The user may then select, or simply begin using, one or more of the ordered datasets.

The initial portion of the use case concerns a query, and trust factor prioritization. Particularly, a user may submit [1] a query that specifies both search parameters, and a list of trust factor definitions, each having had assigned a relative priority or weight, to use to order the result set, that is, the datasets returned in response to the query.

Any one or more of the trust factor definitions may be predefined by the organization, and/or by the user. By way of brief illustration, the query [1] may comprise a ‘Financial’ question asked by the user, and the organization may have defined the trust factor for ‘Financial’ questions as requiring 100% trust. Put another way, the trust factor definition for ‘Financial’ questions specifies 100% trust. The creation of one or more trust factor definitions may happen outside, or within, the context of a data search requested by the user. In any case, when the user performs a search for data, the trust algorithm may automatically, or at the direction of the user, apply the trust factor definitions to the data returned in response to the search.

Using the search parameters provided by the user [1], the system may then retrieve, or receive, data from secondary system inputs [2] for evaluation. Examples of secondary system inputs include data and/or metadata responsive to a search query from a user. Secondary system inputs may additionally, or alternatively include any data and/or metadata, that may impact an actual, and/or perceived, trustworthiness of data such as, but not limited to: identity of the owner of the dataset (ownership may change over time); the origin of the data, that is, the identity and nature of the device, application, or other entity that created the data (origin is static); conformance of the data (parameter that may be tracked by some ETL platforms (Extract, Transform, Load); consistency of the data (parameter that may be tracked by ETL platforms to ensure data is within an acceptable deviation of other data of the same type; and other factors such as, for example, recency of the data, intended destination of the data, intended use of the data, and bias-neutrality.

After receipt of the secondary inputs [2] by the trust algorithm, one or more specified trust factors may be calculated [3], by respective trust factor functions, for the data/metadata of those secondary inputs. The outputs of the trust factor functions may then be aggregated [4] or otherwise combined by a trust score function.

To illustrate, a data string may be evaluated to see if it contains a particular name and, if so, the trust factor function that is looking for a name may output ‘True’ or ‘1’ indicating a relatively high level of trust. On the other hand, if that trust factor function does not find the name in the data string, the trust factor function may output ‘False’ or ‘0,’ indicating no, or low, trust. Still other trust factor functions may examine the same data string for other respective information, such as a birthdate, and a town name, for example. Thus, a set of data may be examined by multiple different trust factor functions.

Note that calculation of one or more trust factors may be omitted in some embodiments. Instead, prior cached calculations, such as calculated trust factor values for example, may be employed. Some embodiments may involve both the use of cached trust factor values, as well as the calculation of trust factor values, while other embodiments may involve only cached values, or only calculated values, respectively. It is further noted that no particular type or number of trust factor calculations are required, and the output of a trust factor calculation may be numerical, alphanumeric, or consist only of words or other alphabetical characters. Thus, in one embodiment, an output of a trust factor calculation may indicate the extent to which a value, or data string, deviates from a standard or expected value, or data string.

A trust score function may then be performed [4] on the aggregation of the trust factor function outputs. In one simple case, the trust score function may be performed on a sum of the outputs of the trust factor functions, if those outputs lend themselves to being summed, such as in the case of numerical outputs. In some embodiments, the respective outputs of the trust factor functions may be weighted to reflect the relative importance of the outputs of the trust factor functions. To continue with the aforementioned data string example, the appearance of a particular name in the data string may be a relatively stronger indicator of trustworthiness that the appearance, or not, of a town name in that same data string. Thus, the output of the trust factor function that is looking for the name in the data string may be weighted relatively greater than the output of the trust factor function that is looking for the town in the data string.

After the trust score has been calculated [4], the trust score and the data with which it is associated may be aggregated together, or otherwise related to each other, to form [5] a result set. The result set may be sorted, for example, by trust score [6], and returned to the user in order of priority. Following is an illustrative example of the method 300 as it might be performed in a hypothetical real world scenario.

A XYZ Corp. employee would like to create a production-decision making algorithm. To build their model, the employee requires a set of data which has only been owned or created by XYZ Corp., or by a certified partner. The employee also requires that data is ‘clean’ and meets the series of conformance and consistency of ‘no variance.’ The employee may then input these needs, or parameters, in the query, and receive, in response to the query, the data in order of score. The employee may then be able to select the data that they need with an understanding of how the data does or does not meet the definition of trust made by the employee.

The same, or another, XYZ Corp. employee may require a different set of data for building a directional report. In this instance, the employee may be open to the use of external data generated outside of XYZ Corp., but may still require a low variance of conformance, or timeframe. The employee may then be able to choose the set of data that has the trust value that the employee requires.

It may further be possible to enable the XYZ Corp. employee to compare the content of more than one data set to create a super-set of data that meets the needs of the user in the terms of “trust,” that is, the trustworthiness of the data. In any, or all, cases, the system may record, such as for repeatability and transparency, the inputs that were the basis for generation of the trust score.

Reference has been made herein to various types and uses of ‘data.’ As used herein, the term ‘data’ is intended to be broad in scope. Thus, that term embraces, by way of example and not limitation, data segments such as may be produced by data stream segmentation processes, data chunks, data blocks, atomic data, emails, objects of any type, files of any type including media files, word processing files, spreadsheet files, and database files, as well as contacts, directories, sub-directories, volumes, and any group of one or more of the foregoing.

Example embodiments of the invention are applicable to any system capable of storing and handling various types of objects, in analog, digital, or other form. Although terms such as document, file, segment, block, or object may be used by way of example, the principles of the disclosure are not limited to any particular form of representing and storing data or other information. Rather, such principles are equally applicable to any object capable of representing information.

Finally, it is noted that embodiments of the invention, whether claimed or not, cannot be performed, practically or otherwise, in the mind of a human. As indicated by the illustrative examples disclosed herein, embodiments of the invention are applicable to, and find practical usage in, complex and dynamic environments. Such environments may include hundreds, thousands, or tens of thousands of customers, or more. Each of the customers may be associated with one or more datasets, each of which may include millions, billions, or more, pieces of data. These datasets may be examined repeatedly to determine their respective trust scores based on the performance of multiple different trust factor functions for each dataset. The datasets may be dynamic in nature, with data being added, modified, and/or deleted, on an ongoing basis.

Given considerations such as these, which are presented by way of example and not limitation, it is clear that performing operations such as the examples noted above, and elsewhere herein, in such complex and dynamic environments is well beyond the mental capabilities of any human to perform practically, or otherwise. Thus, while other, simplistic, examples are disclosed herein, those are only for the purpose of illustration and to simplify the discussion, but do not represent real world applications of embodiments of the invention. Accordingly, nothing herein should be construed as teaching or suggesting that any aspect of any embodiment of the invention could or would be performed, practically or otherwise, in the mind of a human.

### C. FURTHER EXAMPLE EMBODIMENTS

Following are some further example embodiments of the invention. These are presented only by way of example and are not intended to limit the scope of the invention in any way.

Embodiment 1. A method comprising: receiving from a user, by a trust algorithm, primary input that comprises a user query that specifies search parameters, a list of one or more trust factor definitions, and a respective user-specified weighting for each trust factor definition; receiving secondary system inputs and, based on the search parameters, retrieving data from the secondary system inputs; running, on the data retrieved from the secondary system inputs, one or more trust factor functions, each of which generates a respective trust factor; generating a trust score by running a trust score function on the trust factors; aggregating the data with the trust score to create a result set; and storing the result set.

Embodiment 2. The method as recited in embodiment 1, wherein the list of one or more trust factor definitions comprises a list of one or more trust factor definitions that have been prioritized by the user.

Embodiment 3. The method as recited in any of embodiments 1-2, wherein the trust score is associated with a particular point in time.

Embodiment 4. The method as recited in any of embodiments 1-3, wherein calculation of the trust score for the dataset is repeatable.

Embodiment 5. The method as recited in any of embodiments 1-4, wherein the trust score is specific to a context identified by the user in the primary input.

Embodiment 6. The method as recited in embodiment 5, wherein the context includes an intended use of the data.

Embodiment 7. The method as recited in any of embodiments 1-6, wherein each trust factor definition has a respective weight.

Embodiment 8. The method as recited in any of embodiments 1-7, wherein the secondary inputs comprise information identifying a source of the data.

Embodiment 9. The method as recited in any of embodiments 1-8, wherein the result set comprises a list of datasets, sorted according to a relative priority of the trust factor definitions identified by the user.

Embodiment 10. The method as recited in any of embodiments 1-9, wherein performing the method using primary inputs from a second user, but not the first user, results in new set of trust factor definitions and a new trust score different from, respectively, the trust factor definitions and the trust score.

Embodiment 11. A method for performing any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-11.

### F. EXAMPLE COMPUTING DEVICES AND ASSOCIATED MEDIA

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads.

While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

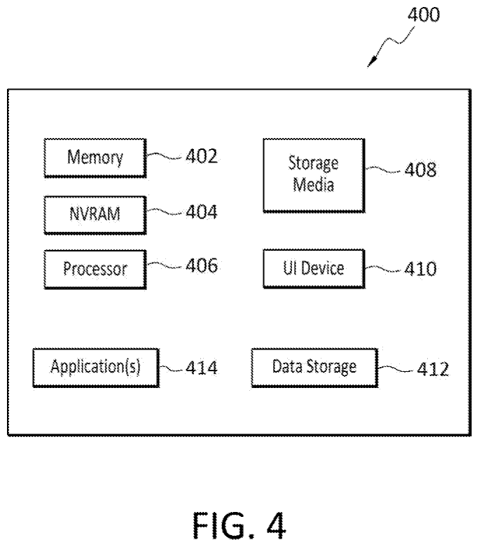

With reference briefly now to FIG. 4, any one or more of the entities disclosed, or implied, by FIGS. 1-3 and/or elsewhere herein, may take the form of, or include, or be implemented on, or hosted by, a physical computing device, one example of which is denoted at 400. As well, where any of the aforementioned elements comprise or consist of a virtual machine (VM), that VM may constitute a virtualization of any combination of the physical components disclosed in FIG. 4.

In the example of FIG. 4, the physical computing device 400 includes a memory 402 which may include one, some, or all, of random access memory (RAM), non-volatile memory (NVM) 404 such as NVRAM for example, read-only memory (ROM), and persistent memory, one or more hardware processors 406, non-transitory storage media 408, UI device 410, and data storage 412. One or more of the memory components 402 of the physical computing device 400 may take the form of solid state device (SSD) storage. As well, one or more applications 414 may be provided that comprise instructions executable by one or more hardware processors 406 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising the operations:
receiving from a user, by a trust algorithm, primary input that comprises a user query that specifies search parameters, a list of one or more trust factor definitions, and a respective user-specified weighting for each trust factor definition;
receiving secondary system inputs and, based on the search parameters, retrieving data from the secondary system inputs;
running, on the data retrieved from the secondary system inputs, one or more trust factor functions, each of which generates a respective trust factor;
generating a trust score by running a trust score function on the trust factors;
aggregating the data with the trust score to create a result set; and
storing the result set.

2. The method as recited in claim 1, wherein the list of one or more trust factor definitions comprises a list of one or more trust factor definitions that have been prioritized by the user.

3. The method as recited in claim 1, wherein the trust score is associated with a particular point in time.

4. The method as recited in claim 1, wherein calculation of the trust score for the dataset is repeatable.

5. The method as recited in claim 1, wherein the trust score is specific to a context identified by the user in the primary input.

6. The method as recited in claim 5, wherein the context includes an intended use of the data.

7. The method as recited in claim 1, wherein each trust factor definition has a respective weight.

8. The method as recited in claim 1, wherein the secondary inputs comprise information identifying a source of the data.

9. The method as recited in claim 1, wherein the result set comprises a list of datasets, sorted according to a relative priority of the trust factor definitions identified by the user.

10. The method as recited in claim 1, wherein performing the method using primary inputs from a second user, but not the first user, results in new set of trust factor definitions and a new trust score different from, respectively, the trust factor definitions and the trust score.

11. A non-transitory storage medium having stored therein instructions that are executable by one or more hardware processors to perform operations comprising:
receiving from a user, by a trust algorithm, primary input that comprises a user query that specifies search parameters, a list of one or more trust factor definitions, and a respective user-specified weighting for each trust factor definition;
receiving secondary system inputs and, based on the search parameters, retrieving data from the secondary system inputs;
running, on the data retrieved from the secondary system inputs, one or more trust factor functions, each of which generates a respective trust factor;
generating a trust score by running a trust score function on the trust factors;
aggregating the data with the trust score to create a result set; and
storing the result set.

12. The non-transitory storage medium as recited in claim 11, wherein the list of one or more trust factor definitions comprises a list of one or more trust factor definitions that have been prioritized by the user.

13. The non-transitory storage medium as recited in claim 11, wherein the trust score is associated with a particular point in time.

14. The non-transitory storage medium as recited in claim 11, wherein calculation of the trust score for the dataset is repeatable.

15. The non-transitory storage medium as recited in claim 11, wherein the trust score is specific to a context identified by the user in the primary input.

16. The non-transitory storage medium as recited in claim 15, wherein the context includes an intended use of the data.

17. The non-transitory storage medium as recited in claim 11, wherein each trust factor definition has a respective weight.

18. The non-transitory storage medium as recited in claim 11, wherein the secondary inputs comprise information identifying a source of the data.

19. The non-transitory storage medium as recited in claim 11, wherein the result set comprises a list of datasets, sorted according to a relative priority of the trust factor definitions identified by the user.

20. The non-transitory storage medium as recited in claim 11, wherein performing the operations using primary inputs from a second user, but not the first user, results in new set of trust factor definitions and a new trust score different from, respectively, the trust factor definitions and the trust score.
